(19) United States
(12) Patent Application Publication
(10) Pub. No.: US 2022/0349513 A1
(43) Pub. Date: Nov. 3, 2022

(54) SHAPE-RESILIENT AND INSULATING COMPONENTS

(71) Applicant: CONCEPT GROUP LLC, Wellesley, MA (US)

(72) Inventors: Shriram RADHAKRISHNAN, West Palm Beach, FL (US); David H. REID, Jr., Fort Pierce, FL (US); Peter ROACH, Jacksonville, FL (US)

(21) Appl. No.: 17/778,115

(22) PCT Filed: Nov. 20, 2020
(86) PCT No.: PCT/US2020/061522

§ 371 Date: May 19, 2022

Related U.S. Application Data
(60) Provisional application No. 62/940,496, filed on Nov. 26, 2019.

(51) Int. Cl. F16L 59/065; F16L 59/14

(52) U.S. Cl. CPC F16L 59/065; F16L 59/141

(57) ABSTRACT

Provided are self-recovering insulating components, comprising: a first boundary in a first configuration; and a second boundary in a first configuration, the first boundary and the second boundary defining a sealed evacuated insulating space therebetween, the sealed insulating space defining a degree of vacuum, and the first boundary, the second boundary, or both and the degree of vacuum being selected such that (i) upon deformation of at least one of the first boundary and the second boundary sufficient to place the first boundary and the second boundary into direct thermal communication with one another at a contact location, (ii) the at least one of the first boundary and the second boundary recovers from the deformation so as to place the component into a recovered configuration free of direct thermal communication between the first boundary and second boundary at the contact location

### RELATED APPLICATIONS

The present application claims priority to and the benefit of U.S. patent application No. 62/940,496, “Shape-Resilient and Insulating Components” (filed Nov. 26, 2019), the entirety of which application is incorporated herein by reference for any and all purposes.

### TECHNICAL FIELD

The present disclosure relates to the field of insulated components and to the field of shape-resilient components and self-cooling fluid transport components.

### BACKGROUND

Insulating components (e.g., flasks, bottles, conduits, piping, and the like) typically include an insulating region (e.g., an air gap, an insulating filler such as fiber, or even a region of sealed vacuum) disposed between first and second boundaries (e.g., inner and outer walls).

Many insulating components, however, are delicate by their nature and can experience a reduction or even a total loss of their insulating capabilities (e.g., via formation of a thermal short wherein the boundaries contact one another so as to form a thermal pathway therebetween) if they are struck, whether in an accidental fashion, during transport, or even during normal usage. As one familiar example, a metal-walled insulated water bottle can lose some of its insulating capabilities if the bottle is dented such that the bottle's inner and outer walls touch one another, as the location of the contact between the inner and outer walls creates a conductive pathway by which heat can be undesirably conducted into (or out of) the interior of the bottle.

Insulating components that contain heated fluids can also, by the nature of the fluid/vapor transition, contain an amount of vapor. The vapor may not be desired, however, and the presence of the vapor can have an effect on the temperature of the contents of the component.

Accordingly, there is a need in the art for improved insulating components, including components capable of retaining or recovering their insulating capabilities after being struck.

### SUMMARY

In meeting the described long-felt needs, the present disclosure provides self-recovering insulating components, comprising: a first boundary in a first configuration; and a second boundary in a first configuration, the first boundary and the second boundary defining a sealed evacuated insulating space therebetween, the sealed insulating space defining a degree of vacuum, and the first boundary, the second boundary, or both and the degree of vacuum being selected such that (i) upon deformation of at least one of the first boundary and the second boundary sufficient to place the first boundary and the second boundary into direct thermal communication with one another at a contact location, (ii) the at least one of the first boundary and the second boundary recovers from the deformation so as to place the component into a recovered configuration that is free of direct thermal communication between the first boundary and second boundary at the contact location.

Also provided are methods, comprising communicating a fluid through a component according to the present disclosure.

Further provided are methods, comprising assembling a component according to the present disclosure.

Additionally disclosed are methods, comprising: with a component according to the present disclosure, placing the first boundary and the second boundary into direct thermal communication with one another.

Further provided is an insulated component, comprising: a first conduit, the first conduit defining a lumen therein, and the lumen being configured to convey a fluid, an insulating boundary, the insulating boundary at least partially enclosing the first conduit, the insulating boundary and the first conduit defining a passage volume therebetween, the insulating boundary optionally comprising a sealed evacuated insulating space disposed within the insulating boundary, and the first conduit comprising at least one passage that places the lumen of the first conduit into fluid communication with the passage volume defined between the first conduit and the insulating boundary.

Also provided are methods, comprising communicating a fluid through the lumen of an insulated component according to the present disclosure.

Further provided are methods, comprising forming an insulated component according to the present disclosure.

Additionally disclosed are insulated components, comprising a first conduit, the first conduit defining a lumen therein, and the lumen being configured to convey a fluid, the first conduit comprising a sealed evacuated insulating space so as to insulate the lumen, an insulating boundary, the insulating boundary at least partially enclosing the first conduit, the insulating boundary and the first conduit defining a passage volume therebetween, the first conduit comprising at least one passage that places the lumen of the first conduit into fluid communication with the passage volume defined between the first conduit and the insulating boundary.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document, and any dimensions given in the drawings are illustrative only and are not-limiting. In the drawings:

FIG. 1A provides a view of an exemplary vacuum-insulated component;

FIG. 1B provides a view of the exemplary component of FIG. 1A following indentation by an external element and formation of a thermal short;

FIG. 1C provides a view of the exemplary component of FIG. 1B following withdrawal of the external element and recovery from the thermal short;

FIG. 1D provides a view of the exemplary component of FIG. 1C, illustrating (without being bound to any particular theory) exemplary forces that can effect the component's recovery from a thermal short;

FIG. 2 provides a cutaway view of an exemplary component according to the present disclosure;

FIG. 3 provides a magnified cutaway view of a region of an exemplary component according to the present disclosure;

FIG. 4 provides a magnified cutaway view of a region of an exemplary component according to the present disclosure;

FIG. 5 provides a cutaway view of an exemplary component according to the present disclosure;

FIG. 6 provides a cutaway view of an exemplary component according to the present disclosure; and

FIG. 7 provides a cutaway view of an exemplary component according to the present disclosure.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

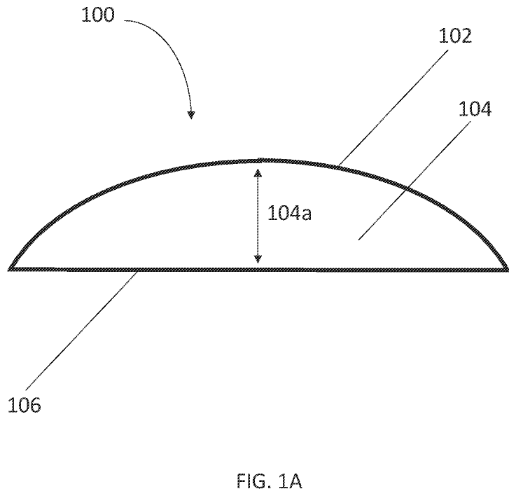

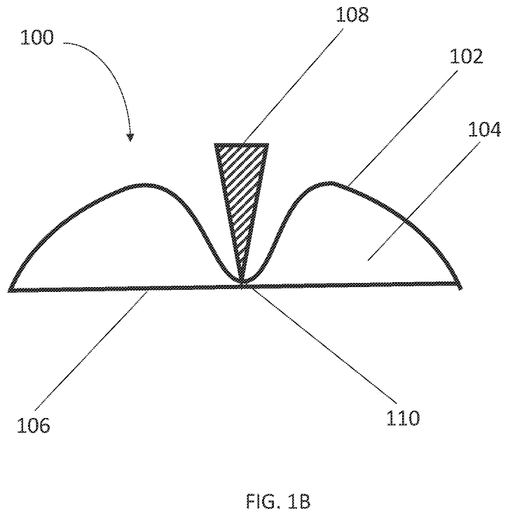

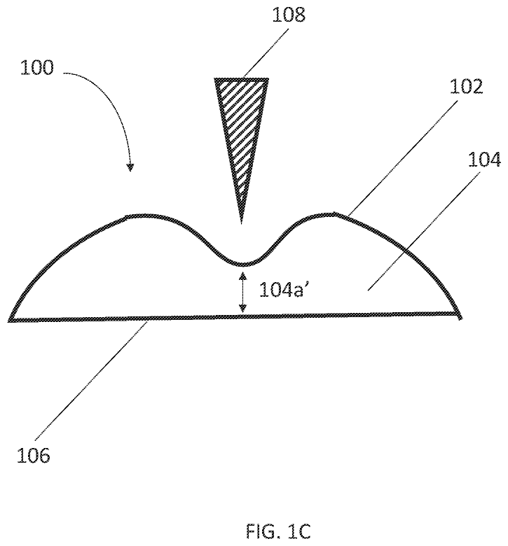

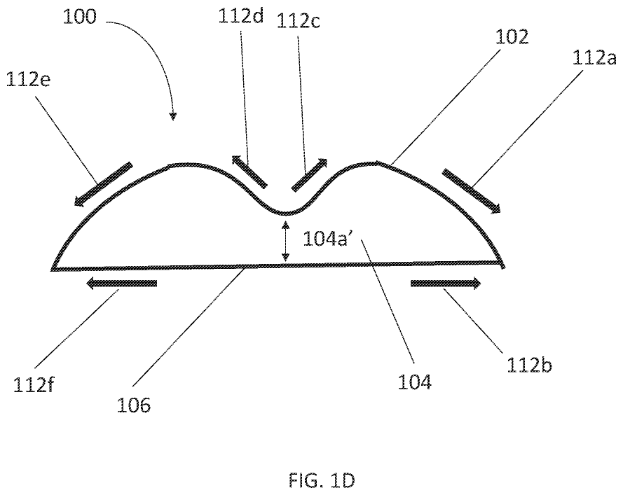

FIG. 1A provides a cutaway view of an exemplary component 100. As shown, a component can include a first boundary 102 and a second boundary 106, with an insulating region 104 disposed therebetween. The insulating region 104 can comprise, e.g., an air gap, a seal vacuum, a fibrous insulator material, and the like. As shown, second boundary 106 can be spaced apart from first boundary 102 by distance 104a. Although FIG. 1A depicts a dome-shaped component, it should be understood that the technology disclosed herein can apply to any geometry, e.g., to a component formed by concentric tubes (e.g., sealed to one another at their ends) that define an insulating region therebetween.

FIG. 1B depicts a cutaway view of exemplary component 100 after the component has been dented by external element 108. As shown, application of force by external element 108 deforms first boundary 102 (e.g., in a dent-type configuration). Such deformation can place first boundary 102 into physical contact with second boundary 106, e.g., at location 110. Such deformation can be intentional, but can also be accidental, e.g., if one component were banged into a shipping package or against another component.

The deformation can give rise to a so-called thermal short, which is a term that describes heat conduction through a physical interface between two elements, e.g., via conduction between the two elements. By reference to FIG. 1B, thermal short 110 is created where first boundary 102 contacts second boundary 106, which contact gives rise to a thermal pathway through which heat can flow. Although not shown in FIG. 1B, distance 104a (by reference to FIG. 1A) can reduced to a value of zero in the case of a thermal short, as first boundary 102 contacts second boundary 106.

FIG. 1C illustrates the recovery of component 100 from the thermal short shown in FIG. 1B. As shown in FIG. 1C, following the removal of external element 108, distance 104a′ (i.e., the distance between the first boundary 102 and the second boundary 106) is a non-zero value, as shown. With the return of distance 104a/104a′ to a non-zero value, component 100 recovers its insulating capabilities.

Without being bound to any particular theory, FIG. 1D provides an exemplary depiction of the forces that act to allow component 100 to recover from the thermal short 110 shown in FIG. 1B. As shown in FIG. 1D, tension, shape-memory, and other forces (112a, 112b, and 112c, with 112d, 112e, and 112f) can act to effectively pull on the deformation in first boundary 102 that was caused by external element 108 (in FIG. 1C; not shown in FIG. 1D) to a degree that the deformation is at least partially reversed enough that there is a non-zero distance 104a′ between first element 102 and second element 106. Distance 104a′ can be, e.g., from about 0.0001 times to about 0.99 times distance 104 (e.g., from about 0.0001 times to about 0.99 times, from about 0.001 times to about 0.95 times, from about 0.01 to about 0.8 times, from about 0.05 to about 0.75 times, from about 0.10 to about 0.60 times, from about 0.20 to about 0.5 times), or from about 0.01 to about 0.3 times distance 104a, or even from about 0.01 to about 0.10 times distance 104a. It should be understood that is it not necessary for the distance between first element 102 and second element 106 to return to its pre-deformation value, as the insulating characteristics of the component can be achieved when at least some spacing exists between first element 102 and second element 106.

Without being bound to any particular theory, the tension created in the material of the deformed boundary (whether the first boundary or the second boundary) can act to effectively “straighten” the dent or other deformation present in the affected boundary. Put another way, because the deformation elongates the affected material, the material may “snap back” to its original configuration, e.g., via the springback effect in certain metals. Again without being bound by any particular theory, so-called work hardening (i.e., the strengthening of a metal by plastic deformation) can contribute to a component having a springback characteristic.

The presence of a vacuum within the sealed evacuated insulating space can also act to pull or otherwise exert a force on the first boundary and/or second boundaries so as to at least partially return the deformed boundary to its earlier, non-deformed configuration. Without being bound to any particular theory, the presence of a vacuum between the walls that define the sealed evacuated insulating space can act to stiffen the overall assembly and facilitate. Again without being bound to any particular theory, the presence of the vacuum facilitates the springback, as the presence of the vacuum acts to place the overall structure under tension.

Without being bound to any particular theory or embodiment, shape-memory materials (e.g., shape-memory alloys) are considered particularly suitable materials for use in the disclosed components. Copper-aluminium-nickel and nickel-titanium (NiTi) alloys are considered suitable; shape-memory alloys can also be created by alloying zinc, copper, gold and iron, e.g., Fe—Mn—Si, Cu—Zn—Al and Cu—Al—Ni. It should be understood that one, both, or neither of the first boundary and the second boundary can be formed from a shape-memory alloy.

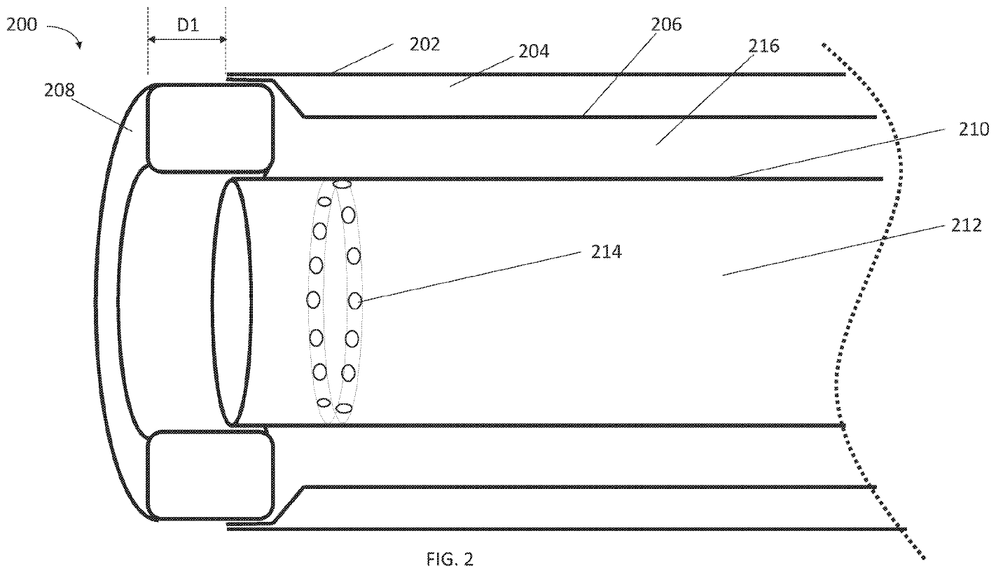

FIG. 2 provides an illustration of another exemplary component 200 according to the present disclosure. As shown, component 200 can include a first conduit 210, which first conduit defines a lumen 212 therein. The first conduit can include one or more passages 214. A passage (214) can place the lumen into fluid communication with passage volume 216, which passage volume 216 is defined between first conduit 210 and insulating boundary 204. A passage can be sized so as to admit vapor but not liquid; a passage can also comprise a screen or other barrier that prevents the passage of liquid while at the same time permitting the passage of vapor.

Insulating boundary 204 can be defined by first wall 202 and second wall 206. First wall 202 and second wall 206 can be joined so as to firm a vent. Exemplary vents, e.g., vents incorporating a converging wall exit geometry for an insulating space to guide gas particles from the space like a funnel) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes.

First wall 202 and second wall 206 can define an evacuated insulating space therebetween. Passage volume can be further defined by sealing ring 208. Distance D1 can describe the distance between the edge of sealing ring 218 and the edge (or end) of insulating boundary 204. Sealing ring 208 can be configured so as to form a vent that acts to encourage molecular exits from the passage volume 216. Suitable vents (e.g., vents incorporating a converging wall exit geometry for an insulating space to guide gas particles from the space like a funnel) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes. It should be understood that sealing ring 208 is optional, and first conduit 210 can be sealed directly to first wall 202 or second wall 206.

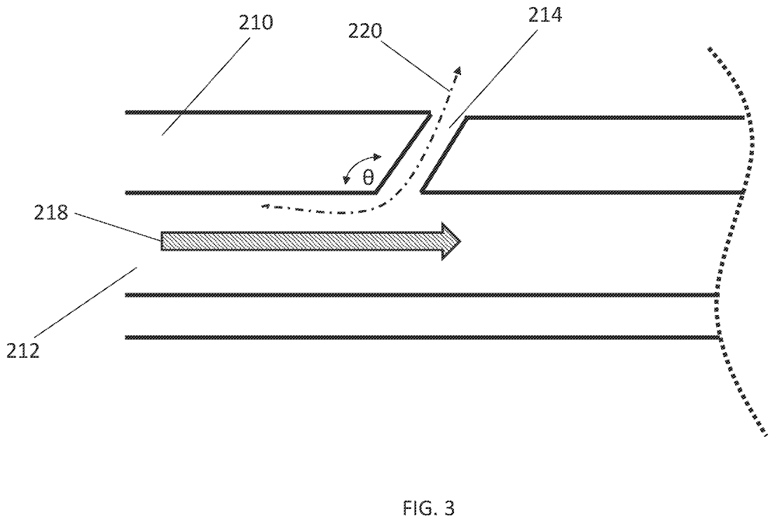

FIG. 3 provides a magnified view of a region of an exemplary component according to the present disclosure. As shown, passage 214 is formed in first conduit 210 so as to place the lumen 212 of the first conduit in fluid communication with the environment exterior to the first conduit, e.g., the passage volume 216 of FIG. 2. As shown, when a fluid moves in a direction 218, fluid (or a vapor derived from that fluid) can transit passage 214. As shown, passage 214 can be at an angle θ relative to the major axis of the lumen 212. Angle θ can be from 0 to 180 degrees, or from about 3 to about 177 degrees, or from about 10 to about 170 degrees, or from about 20 to about 160 degrees, from about 30 to about 150 degrees, or from about 40 to about 140 degrees, or from about 50 to about 130 degrees, or from about 70 to about 110 degrees, or from about 80 to about 100 degrees, or about 90 degrees. Angle θ can be acute or obtuse, and can even be a right angle.

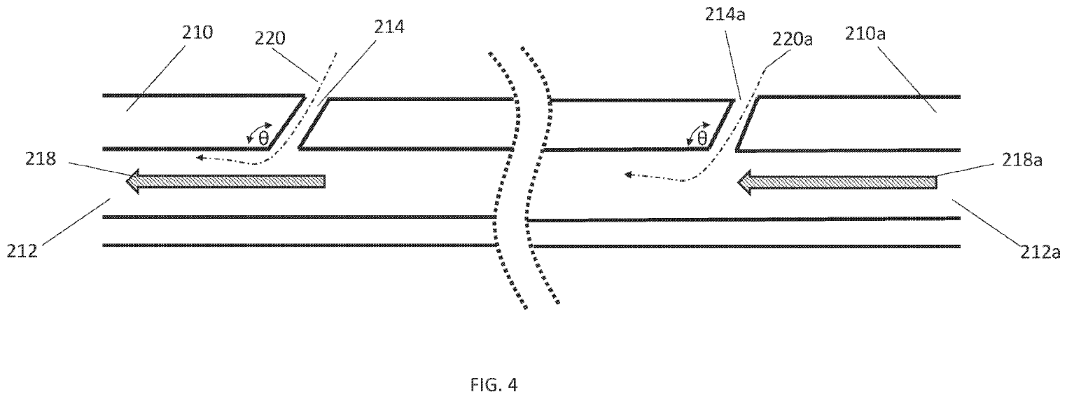

FIG. 4 provides a magnified view of a region of an exemplary component according to the present disclosure. As shown, passage 214 is formed in first conduit 210 so as to place the lumen 212 of the first conduit in fluid communication with the environment exterior to the first conduit, e.g., the passage volume 216 of FIG. 2. As shown, when a fluid moves in a direction 218, fluid (or a vapor derived from that fluid) can transit passage 214. As shown, passage 214 can be at an angle θ relative to the major axis of the lumen 212. Angle θ can be from 0 to 180 degrees, or from about 3 to about 177 degrees, or from about 10 to about 170 degrees, or from about 20 to about 160 degrees, from about 30 to about 150 degrees, or from about 40 to about 140 degrees, or from about 50 to about 130 degrees, or from about 70 to about 110 degrees, or from about 80 to about 100 degrees, or about 90 degrees. Angle θ can be acute or obtuse, and can even be a right angle.

Although not shown in FIG. 4, a component can be formed of one, two, three, or more sections of conduit. As an example, two sections of conduit can be arranged such that the lumens of each conduit are in fluid communication with one another. The conduits can be arranged such that there is a gap between the ends of the conduits (e.g., the ends of the conduits are not butted up exactly against one another), whereby the gap acts as a passage (e.g., similar to passage 214 shown in FIG. 4) that places the lumens of the conduits into fluid communication with the environment (e.g., a passage volume) exterior to the conduits.

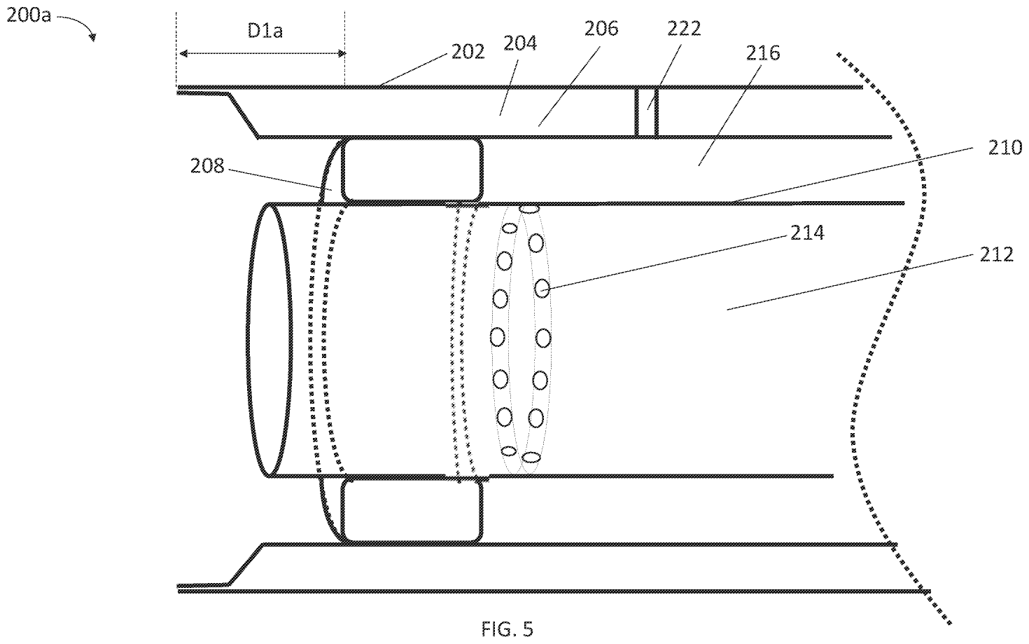

FIG. 5 provides an illustration of an exemplary component 200 according to the present disclosure. As shown, component 200 can include a first conduit 210, which first conduit defines a lumen 212 therein. The first conduit can include one or more passages 214. Passage 214 can place the lumen into fluid communication with passage volume 216, which passage volume 216 is defined between first conduit 210 and insulating boundary 204. Insulating boundary 204 can be defined by first wall 202 and second wall 206. First wall 202 and second wall 206 can define an evacuated insulating space therebetween. First wall 202 and second wall 206 can be joined so as to firm a vent. Exemplary vents, e.g., vents incorporating a converging wall exit geometry for an insulating space to guide gas particles from the space like a funnel) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes.

Passage volume can be further defined by sealing ring 208. Distance D1a can describe the distance between the edge of sealing ring 218 and the edge (or end) of insulating boundary 204. Sealing ring 208 can be configured so as to form a vent that acts to encourage molecular exits from the passage volume 216. Suitable vents (e.g., vents incorporating a converging wall exit geometry for an insulating space to guide gas particles from the space like a funnel) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes.

Thermal short 222 (which is optional) provides a thermal pathway across the insulating boundary 204 between the passage volume 216 and the environment exterior to the insulating boundary 204. In some embodiments, a further passage (not shown) can place the passage volume 216 into fluid communication with the environment exterior to the insulating boundary.

Thermal short 222 can be a pillar or other physical structure that physically connects first wall 202 and second wall 206 across the insulating boundary 204. Thermal short 222 can also be a location of direct contact between first wall 202 and second wall 206, e.g., a location where first wall 202 and second wall 206 are pinched together such that they contact one another.

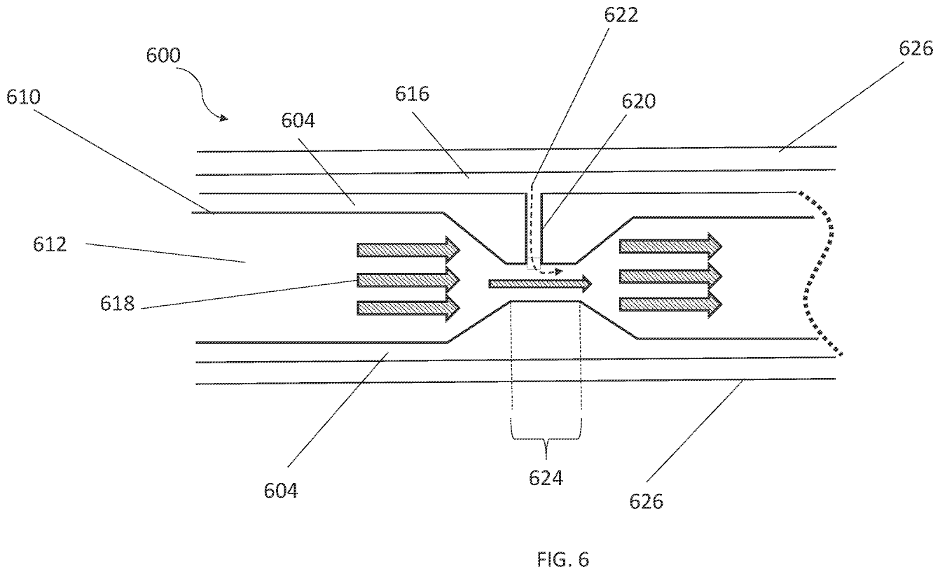

FIG. 6 provides a view of a further exemplary component 600 according to the present disclosure. As shown, component 600 can include a first conduit 610, which conduit defines lumen 612 therein. First conduit 610 can be at least partially enclosed by boundary 626, such that first conduit 610 and boundary 626 define passage volume 616 therebetween. Boundary 626 can be a wall (e.g., a tube). Boundary 626 can comprise insulation, e.g., an insulating material such as a fibrous or porous material. Boundary 626 can also include an evacuated region, e.g., a sealed region (such as one between an inner wall and an outer wall) that is at less than atmospheric pressure. An evacuated region can be at a pressure of, e.g., from 10⁻¹ Torr to 10⁻⁷ Torr, or from 10⁻² Torr to 10⁻⁷ Torr, or from 10⁻³ Torr to 10⁻⁷ Torr, or from 10⁻⁴ Torr to 10⁻⁷ Torr, or from 10⁻⁵ Torr to 10⁻⁷ Torr, or even from 10⁻⁶ Torr to 10⁻⁷ Torr. Suitable such regions (e.g., vents incorporating a converging wall exit geometry for an insulating space to guide gas particles from the space like a funnel) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes.

Lumen 612 can be of constant cross-section. Lumen 612 can also be of variable cross-section. As shown, lumen 612 can include a narrowed region 624, which narrowed region defines a smaller cross-section (e.g., diameter) than the regions adjacent to the narrowed region. A narrowed region can itself be of a constant cross-section; as shown in FIG. 6, a narrowed region can be of a constant cross-section and be flanked by one or more regions that taper inward to the narrowed region. It is not a requirement, however, that the narrowed region be of a constant cross-section. As shown in FIG. 6, lumen 612 can have a relatively wide region that transitions (e.g., via a linear taper or even a non-linear taper) to a relatively narrow region, which relatively narrow region can transition to a relatively wide region (e.g., via a linear taper or even a non-linear taper).

First conduit 610 can include insulating portion 604. An insulating portion can be an evacuated region, e.g., a sealed region that is at less than atmospheric pressure. Suitable such regions (e.g., vents incorporating a converging wall exit geometry for an insulating space to guide gas particles from the space like a funnel) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes. Insulating portion 604 can also comprise an insulating material therein, e.g., an fibrous insulating material, a porous insulating material, and combinations thereof.

First conduit 610 can include passage 620. Passage 620 can place lumen 612 into fluid communication with passage volume 616. Without being bound to any particular theory, passage of fluid (shown by directional arrow 618) within lumen 612 can give rise to a fluid effect so as to draw into lumen 612 (via passage 620) fluid disposed within passage volume 616. (This is illustrated in a non-limiting fashion by fluid path 622, which illustrates the effect exerted on fluid disposed within passage volume 616.)

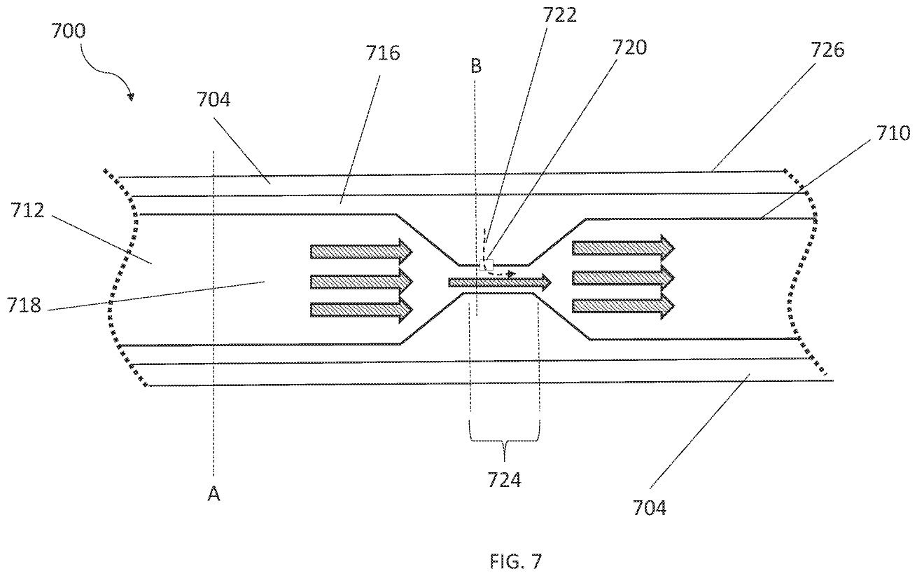

FIG. 7 provides a view of an exemplary component 700 according to the present disclosure. As shown, component 700 can include a first conduit 710, which conduit defines lumen 712 therein. First conduit 710 can be at least partially enclosed by boundary 726, such that first conduit 710 and boundary 726 define passage volume 716 therebetween.

Boundary 726 can include insulating space 704. Insulating space 704 can include an evacuated region, e.g., a sealed region that is at less than atmospheric pressure. An evacuated region can be at a pressure of, e.g., from 10⁻¹ Torr to 10⁻⁷ Torr, or from 10⁻² Torr to 10⁻⁷ Torr, or from 10⁻³ Torr to 10⁻⁷ Torr, or from 10⁻⁴ Torr to 10⁻⁷ Torr, or from 10⁻⁵ Torr to 10⁻⁷ Torr, or even from 10⁻⁶ Torr to 10⁻⁷ Torr. Suitable such regions (e.g., vents incorporating a converging wall exit geometry for an insulating space to guide gas particles from the space like a funnel) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes. Boundary 726 can be a wall (e.g., a tube). Insulating space 704 can comprise insulation, e.g., an insulating material such as a fibrous or porous material. Lumen 712 can be of constant cross-section. Lumen 712 can also be of variable cross-section. As shown, lumen 712 can include a narrowed region 724, which narrowed region defines a smaller cross-section (e.g., diameter) than the regions adjacent to the narrowed region. A narrowed region can itself be of a constant cross-section; as shown in FIG. 7, a narrowed region can be of a constant cross-section and be flanked by one or more regions that taper inward to the narrowed region. It is not a requirement, however, that the narrowed region be of a constant cross-section. As shown in FIG. 7, lumen 712 can have a relatively wide region that transitions to a relatively narrow region, which relatively narrow region can transition to a relatively wide region.

First conduit 710 can include passage 720. Passage 720 can place lumen 712 into fluid communication with passage volume 716. Without being bound to any particular theory, passage of fluid (shown by directional arrow 722) within lumen 712 can give rise to a fluid effect so as to draw into lumen 712 (via passage 720) fluid disposed within passage volume 716. (This is illustrated in a non-limiting fashion by fluid path 722, which illustrates the effect exerted on fluid disposed within passage volume 716.)

Passage volume 716 can have a variable cross-sectional area or profile along its length. For example, passage volume 716 can (as shown in FIG. 7) include a region that is relatively large in cross section (e.g., the region surrounding narrowed region 724), and a region that is relatively narrow in cross section.

The total amount of cross-sectional area available to fluid flow in the passage volume and in the lumen can remain constant, but the relative amounts of that cross-sectional area can vary along the length of the component. For example, and as shown in FIG. 7, where the lumen has a relatively large diameter at location A, the cross-sectional area of flow in the passage volume 116 is less than the cross-sectional area of flow in the passage volume 116 at location B, where the lumen has a relatively small diameter.

### Exemplary Embodiments

The following embodiments are exemplary only and do not serve to limit the scope of the present disclosure or of the appended claims.

Embodiment 1. A self-recovering insulating component, comprising: a first boundary in a first configuration; and a second boundary in a first configuration, the first boundary and the second boundary defining a sealed evacuated insulating space therebetween, the sealed insulating space defining a degree of vacuum, and the first boundary, the second boundary, or both and the degree of vacuum being selected such that (i) upon deformation of at least one of the first boundary and the second boundary sufficient to place the first boundary and the second boundary into direct thermal communication with one another at a contact location, (ii) the at least one of the first boundary and the second boundary recovers from the deformation so as to place the component into a recovered configuration that is free of direct thermal communication between the first boundary and second boundary at the contact location.

By “direct thermal communication” is meant a continuous physical path of material such that heat can flow directly from the first boundary to the second boundary along the continuous physical path. As one example, direct thermal communication is present when the first boundary and the second boundary contact one another, e.g., if they were pinched together. Direct thermal contact would also be present when a metallic foil is placed between the first boundary and the second boundary and then one or both of the first boundary and the second boundary are bent or otherwise advanced toward one another such that the first boundary and the second boundary both contact the metallic foil, with the metallic foil thereby serving as part of the continuous physical path between the first boundary and the second boundary. A location of “direct thermal communication” can also be termed a “thermal short.”

The evacuated region is suitably at a pressure of less than about 760 Torr. Pressures of about 10⁻¹, 10⁻², 10⁻³, 10⁻⁴, 10⁻⁵, 10⁻⁶, and even about 10⁻⁷ Torr (and all intermediate ranges and values) are all considered suitable. The evacuated region can be formed by a variety of methods, e.g., the methods provided in U.S. Pat. Nos. 7,681,299 and 7,374,063 and in U.S. patent application Ser. No. 12/766,397 (all incorporated herein by reference in their entireties for any and all purposes), in which walls are vacuum brazed together so that a vacuum chamber is formed between the walls.

It should be understood that it is not a requirement that both the first boundary and the second boundary are flexible or resilient materials. As an example, the first boundary (e.g., outer boundary) can be a metallic material, such as a shape-memory alloy, and the second boundary (e.g., inner boundary) is a ceramic material.

A boundary can have virtually shape. For example, a boundary can be a planar wall, a curved wall, a disc, a convex shape, a concave shape, a constant-curvature shape, a variable-curvature shape, and the like.

The first boundary and the second boundary can be formed of the same material, but can also be formed of different materials. As an example (described elsewhere herein), the first boundary (e.g., an outer wall that is exposed to the environment exterior to the component) can be a metallic material and the second boundary (e.g., an inner wall) can be a ceramic material. In this way, a component can be configured such that the outer-facing wall is one that is of a resilient material.

Embodiment 2. The insulating component of Embodiment 1, wherein at least one of the first boundary and the second boundary is characterized as being tubular. In one embodiment, the first boundary and the second boundary are arranged as concentric tubes.

Embodiment 3. The insulating component of any one of Embodiments 1-2, wherein the sealed insulating space is characterized as annular. Insulating spaces need not be annular, however, as they can conform to the shapes of the first boundary and second boundary. For example, an insulating space can be dome-shaped, cylindrical, polygonal, or otherwise shaped according to a user's specifications.

Embodiment 4. The insulating component of any one of Embodiments 1-3, wherein at least one of the first boundary and the second boundary is characterized as being arcuate.

Embodiment 5. The insulating component of any one of Embodiments 1-4, wherein (a) the first boundary and the second boundary define a distance D therebetween measured along a line drawn between the first boundary in its first configuration and the second boundary in its first configuration, and (b) in the recovered configuration, the first boundary and the second boundary define a distance of from about 0.0001 D and about 0.99 D therebetween (e.g., from about 0.0001 to about 0.99 D, from about 0.001 to about 0.90 D, from about 0.01 to about 0.80 D, from about 0.1 to about 0.75 D, from about 0.2 to about 0.6 D, or even from about 0.3 to about 0.5 D), as measured along the line drawn between the first boundary and the second boundary.

By reference to FIG. 1A and FIG. 1C, distance 104a′ can be from about 0.0001 of distance 104a to about 0.99 of distance 104a (e.g., from about 0.0001 times to about 0.99 times, from about 0.001 times to about 0.95 times, from about 0.01 to about 0.8 times, from about 0.05 to about 0.75 times, from about 0.10 to about 0.60 times, from about 0.20 to about 0.5 times), and all intermediate values and ranges, e.g., distance 104a′ can be from about 0.01 of distance 104a to about 0.10 of distance 104a.

Embodiment 6. The insulating component of Embodiment 5, wherein in the recovered configuration, the first boundary and the second boundary define a distance of from about 0.01 D and about 0.30 D therebetween, as measured along the line drawn between the first boundary and the second boundary.

Embodiment 7. The insulating component of any one of Embodiments 1-6, further comprising a material disposed within the sealed evacuated insulating space. Such a material can be used to maintain physical separation between the first boundary and the second boundary. Woven materials (e.g., woven ceramic sheets or ribbons) can be used.

Embodiment 8. The insulating component of Embodiment 7, wherein the material comprises a fibrous material, a reflective material, a porous material, a woven material, a nonwoven material, or any combination thereof.

Embodiment 9. The insulating component of Embodiment 8, wherein the reflective material comprises a metallic material. Reflective materials, e.g., stainless steel, polished copper, and the like can be used.

Embodiment 10. The insulating component of any one of Embodiments 1-9, wherein at least one of the first boundary and the second boundary comprises a metallic material.

Embodiment 11. The insulating component of any one of Embodiments 1-10, wherein the first boundary, the second boundary, or both and the degree of vacuum being selected such that (i) upon deformation of at least one of the first boundary and the second boundary sufficient to place the first boundary and the second boundary into direct thermal communication with one another at a second contact location, (ii) the at least one of the first boundary and the second boundary recovers from the deformation so as to place the component into a recovered configuration that is free of direct thermal communication between the first boundary and second boundary at the second contact location.

As explained, a component can be configured such that it can recover from one, two, or more deformations that create thermal shorts. In this way, a component, e.g., a tube of significant length, can retain its insulating capabilities even if deformed in one or more locations.

Embodiment 12. The insulating component of any one of Embodiments 1-11, further comprising a jacket disposed about the first boundary.

Embodiment 13. The insulating component of any one of Embodiments 1-12, wherein the second boundary defines a lumen therein.

Embodiment 14. A method, comprising communicating a fluid through a component according to any one of Embodiments 1-13.

Embodiment 15. A method, comprising assembling a component according to any one of Embodiments 1-14.

Embodiment 16. A method, comprising: with a component according to any one of Embodiments 1-13, placing the first boundary and the second boundary into direct thermal communication with one another.

Embodiment 17. An insulated component, comprising: a first conduit, the first conduit defining a lumen therein, and the lumen being configured to convey a fluid, an insulating boundary, the insulating boundary at least partially enclosing the first conduit, the insulating boundary and the first conduit defining a passage volume therebetween, the insulating boundary optionally comprising a sealed evacuated insulating space disposed within the insulating boundary, and the first conduit comprising at least one passage that places the lumen of the first conduit into fluid communication with the passage volume defined between the first conduit and the insulating boundary.

Embodiment 18. The insulated component of Embodiment 17, further comprising at least one sealing element that at least partially defines the passage volume between the insulating boundary and the first conduit. The sealing element can be sealed to the first conduit so as to form a vent, the vent being sealable for maintaining a vacuum within the insulating space following evacuation of gas molecules through the vent, the distance between the first and second walls being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress thereby providing a deeper vacuum without requiring a getter material within the insulating space.

The sealing element can also be sealed to the insulating boundary so as to form a vent, the vent being sealable for maintaining a vacuum within the insulating space following evacuation of gas molecules through the vent, the distance between the first and second walls being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress thereby providing a deeper vacuum without requiring a getter material within the insulating space.

Embodiment 19. The insulated component of Embodiment 18, wherein the sealing element comprises an annular element.

Embodiment 20. The insulated component of any one of Embodiments 17-19, wherein the insulating boundary defines a proximal end and a distal end, wherein the first conduit defines a proximal end and a distal end, and wherein at least some of the at least one sealing element is located proximal to at least one of (i) the proximal end of the insulating boundary or (ii) the proximal end of the first conduit.

Embodiment 21. The insulated component of Embodiment 20, wherein the at least one passage of the first conduit is located distal to the at least one sealing element.

Embodiment 22. The insulated component of any one of Embodiments 17-21, wherein the insulating boundary defines a proximal end and a distal end, wherein the first conduit defines a proximal end and a distal end, and wherein at least some of the at least one sealing element is located distal to at least one of (i) the proximal end of the insulating boundary or (ii) the proximal end of the first conduit.

Embodiment 23. The insulated component of Embodiment 22, wherein the at least one passage of the first conduit is located distal to the at least one sealing element.

Embodiment 24. The insulated component of any one of Embodiments 17-23, wherein the lumen is configured to convey the fluid in a flow direction, and wherein the at least one passage is oriented perpendicular to the flow direction.

Embodiment 25. The insulated component of any one of Embodiments 17-23, wherein the lumen is configured to convey the fluid in a flow direction, and wherein the at least one passage is non-perpendicular to the flow direction.

Embodiment 26. The insulated component of any one of Embodiments 17-25, wherein the first conduit comprises an evacuated insulating space disposed within the insulated component.

Embodiment 27. The insulated component of any one of Embodiments 17-26, wherein the insulating boundary comprises a passage configured to place the passage volume into fluid communication with the environment exterior to the insulating boundary.

Embodiment 28. The insulated component of any one of Embodiments 17-27, wherein the first conduit defines a length of at least about 5 cm.

Embodiment 29. The insulated component of any one of Embodiments 17-28, wherein the insulating boundary defines a length of at least about 5 cm.

Embodiment 30. The insulated component of any one of Embodiments 17-29, wherein the at least one passage is sized so as to permit passage of vapor without passage of liquid.

Embodiment 31. A method, comprising communicating a fluid through the lumen of an insulated component according to any one of Embodiments 17-30.

Embodiment 32. The method of Embodiment 31, wherein the fluid is present under such conditions that the fluid evolves a vapor, at least some of which vapor communicates through the at least one passage.

Embodiment 33. The method of Embodiment 32, wherein the fluid is at a temperature of from about −300 to about 300 deg. C.

Embodiment 34. The method of any one of Embodiments 31-33, wherein the fluid comprises liquid helium, liquid nitrogen, or any combination thereof.

Embodiment 35. The method of any one of Embodiments 32-34, further comprising recovering at least some of the vapor that communicates through the at least one passage to the passage volume.

Embodiment 36. The method of Embodiment 35, further comprising condensing at least some of the vapor that communicates through the at least one passage.

Embodiment 37. The method of any one of Embodiments 35-36, further comprising communicating at least some of the vapor communicated to the passage volume out of the passage volume.

Embodiment 38. The method of any one of Embodiments 31-37, further comprising dispensing fluid communicated through the lumen.

Embodiment 39. The method of any one of Embodiments 31-38, wherein the fluid experiences a change in temperature of less than about 5 deg. C upon communication through the lumen.

Embodiment 40. The method of any one of Embodiments 31-38, wherein the fluid experiences a change in temperature of between about 0.0001 to about 3 deg. C. upon communication through the lumen.

Embodiment 41. The method of any one of Embodiments 31-38, wherein communicating the fluid through the lumen effects a reduced pressure in the passage volume.

Embodiment 42. A method, comprising forming an insulated component according to any one of Embodiments 17-30.

1. A self-recovering insulating component, comprising:
a first boundary in a first configuration; and
a second boundary in a first configuration,
the first boundary and the second boundary defining a sealed evacuated insulating space therebetween,
the sealed insulating space defining a degree of vacuum, and
the first boundary, the second boundary, or both and the degree of vacuum being selected such that (i) upon deformation of at least one of the first boundary and the second boundary sufficient to place the first boundary and the second boundary into direct thermal communication with one another at a contact location, (ii) the at least one of the first boundary and the second boundary recovers from the deformation so as to place the component into a recovered configuration that is free of direct thermal communication between the first boundary and second boundary at the contact location.

2. The insulating component of claim 1, wherein at least one of the first boundary and the second boundary is characterized as being tubular.

3. The insulating component of claim 1, wherein the sealed insulating space is characterized as annular.

4. The insulating component of claim 1, wherein at least one of the first boundary and the second boundary is characterized as being arcuate.

5. The insulating component of claim 1, wherein (a) the first boundary and the second boundary define a distance D therebetween measured along a line drawn between the first boundary in its first configuration and the second boundary in its first configuration, and (b) in the recovered configuration, the first boundary and the second boundary define a distance of from about 0.0001 D and about 0.99 D therebetween, as measured along the line drawn between the first boundary and the second boundary.

6. The insulating component of claim 5, wherein in the recovered configuration, the first boundary and the second boundary define a distance of from about 0.01 D and about 0.30 D therebetween, as measured along the line drawn between the first boundary and the second boundary.

7. The insulating component of claim 1, further comprising a material disposed within the sealed evacuated insulating space.

8. The insulating component of claim 7, wherein the material comprises a fibrous material, a reflective material, a porous material, a woven material, a nonwoven material, or any combination thereof.

9. The insulating component of claim 8, wherein the reflective material comprises a metallic material.

10. The insulating component of claim 1, wherein at least one of the first boundary and the second boundary comprises a metallic material.

11. The insulating component of claim 1, wherein the first boundary, the second boundary, or both and the degree of vacuum being selected such that (i) upon deformation of at least one of the first boundary and the second boundary sufficient to place the first boundary and the second boundary into direct thermal communication with one another at a second contact location, (ii) the at least one of the first boundary and the second boundary recovers from the deformation so as to place the component into a recovered configuration that is free of direct thermal communication between the first boundary and second boundary at the second contact location.

12. The insulating component of claim 1, further comprising a jacket disposed about the first boundary.

13. The insulating component of claim 1, wherein the second boundary defines a lumen therein.

14. A method, comprising communicating a fluid through a component according to claim 1.

15. A method, comprising assembling a component according to claim 1.

16. A method, comprising:
with a component according to claim 12, placing the first boundary and the second boundary into direct thermal communication with one another.

17-43. (canceled)
